(19) United States
(12) Patent Application Publication
(10) Pub. No.: US 2023/0302312 A1
(43) Pub. Date: Sep. 28, 2023

(54) Hazard Containment System

(71) Applicant: Wolfgang Kneer, Tuscaloosa, AL (US)

(72) Inventor: Wolfgang Kneer, Tuscaloosa, AL (US)

(21) Appl. No.: 18/126,784

(22) Filed: Mar. 27, 2023

Related U.S. Application Data
(60) Provisional application No. 63/323,519, filed on Mar. 25, 2022.

(51) Int. Cl. A62C 2/06; B65D 88/74; B65D 90/04

(52) U.S. Cl. CPC A62C 2/06; B65D 88/745; B65D 90/045; B65D 2590/023

(57) ABSTRACT

The present application provides a hazard containment system (“HCS”) and method of using the same. The HCS includes an outer liner, which is based on the re-use of available shipping containers, and an inner liner thus providing a “double walled” system.

### CROSS-REFERENCE TO RELATED APPLICATIONS

This application claims priority to, and the benefit of, pending U.S. Provisional Patent Application No. 63/323,519 filed on Mar. 25, 2022.

### FIELD OF THE DISCLOSURE

The present disclosure pertains to the field of a system and method of containing hazard materials, especially for the batteries of Electric Vehicles (“EVs”) or battery powered Electric Vehicles themselves.

### BACKGROUND

Batteries, especially large capacity batteries such as those in electric or hybrid automobiles, pose a significant risk of fire, melt-down or even explosion, including the environmental aspect of not being able to contain ingredients of such batteries. When those batteries do suffer a malfunction and potentially catch fire or present a hazardous condition for the environment and surrounding people, they are difficult to contain and extinguish as they potentially burn hotter but mostly longer than a typical automobile fire. In addition, leaking material from a battery cannot just be swept away or contained and should be transported safely to proper recycling agencies. Extinguishing battery fire requires more water (or other material) and may not prevent reignition hours or days after the initial fire is extinguished. This presents a significant threat to salvage yards, automobile dealers, repair shops and transporters as well as charging stations, which all could potentially present risk to such batteries for overheating, overcharging, spark-initiation or any other malfunction. Accordingly, there is a need in the art for a containment system which is cost efficient, readily deployable, reusable, and safe for the containment and eventual extinguishment of such hazard. The present application provides such a hazard containment system that is useful for the containment of many hazardous materials such as car batteries or other materials that would or could pose a safety risk.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows one embodiment of the hazard containment system of the present disclosure.

FIG. 2 shows an alternate view of the hazard containment system of FIG. 1.

### DETAILED DESCRIPTION

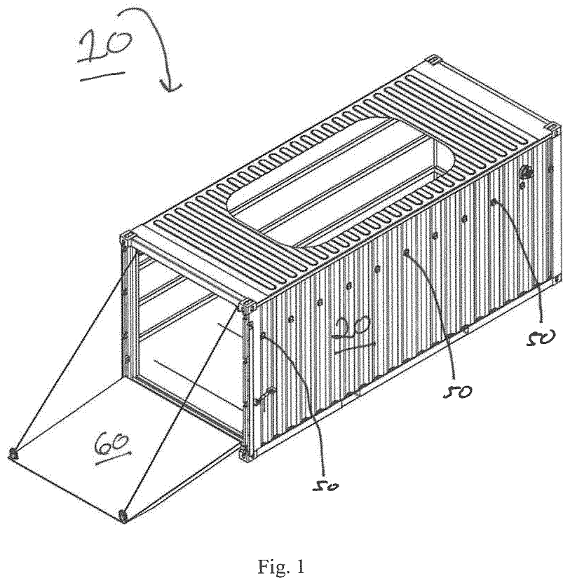

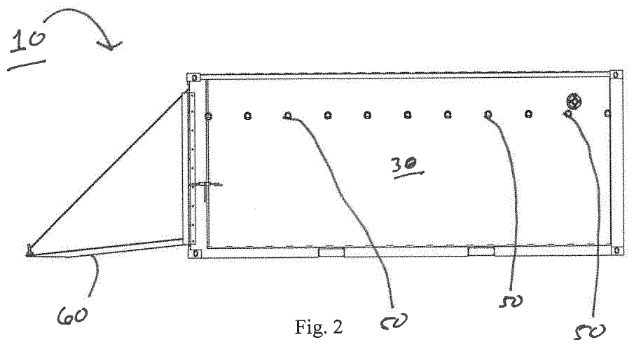

Now referring to FIGS. 1 and 2, the present application provides a hazard containment system 10 (“HCS”) and method of using the same. The HCS 10 includes an outer liner 20, which is based on the re-use of available shipping containers, and an inner liner 30 thus providing a “double walled” system. The use of the double wall system provides many advantages, including without limitation increasing the total thermal resistance/strength of the HCS 10, allowing the outer liner 20 to be reused/recycled, allowing the addition of automatic fire suppression measures to the inner liner 30, and finally the outer liner can be of standard size/dimension allowing for easy transport. The HCS 10 may contain the hazardous materials present after a fire for weeks preventing the re-ignition of the fire (a known problem with electric battery fires).

In one embodiment, the outer liner 20 may be a standard shipping container that are commonly used in the transportation of goods around the world. These “shipping containers” (commonly 20 feet long) are made of robust and sturdy materials, such as corten steel (or weathering steel). Corten steel is distinguished from other types of steel in that it is a group of steel alloys that were developed to eliminate the need for painting. Container manufacturers use this material because it possesses the physical properties that make it weldable and rust resistant, weather resistant and practicably resistant to high temperatures or even cold temperatures and spray of road salt while in Northern Regions, which elsewhere could cause quicker rust impact. In practice, rust resistance means that should a piece of paint chip off of the steel, a thin layer of rust will form at the surface but not go much deeper. Accordingly, corten steel is very durable and long lasting. Another advantage to using a shipping container as the outliner 20 is that they are of known size and dimension and provides prefabricated outer structures that allow for easy pick-up (e.g. by crane or fork-lift) and easier transportation before or after use of the system 10 (e.g. by truck, ship, railroad). Additionally, shipping containers are of sufficient size to accommodate most passenger automobiles, which make up the great majority of electric automobiles. Such shipping containers are also used by many fire brigades around the world for fire-drills and used as safe-storage.

In one embodiment, the inner liner 30 is adapted or configured to fit within the outer liner 20. The inner liner 30 may be constructed from other sturdy materials, such as A36 steel, fire resistant material or ceramic tiles. The use of a sturdy material to construct the inner liner 30 provides a double wall system which in turn provides an extra layer of protection to contain both a fire and any hazardous materials present inside of the system 10. Additionally, the inner liner 30 may be removed from the outer liner 20, in one embodiment, thus allowing the outer liner 20 to be reused multiple times. Further, the hazard containment system 10 may optionally include an opening on its roof (or ceiling) to allow heat, smoke or the like to be released. In this embodiment, the hazard containment system 10 may include a moveable flap over the roof opening.

In one embodiment, there is a gap or space 40 between the outer liner 20 and the inner liner 30. This gap or space 40 can be filled with other fire-retardant materials such as foam or cement if desired to further add to the thermal resistance of the system 10. The gap or space 40 also, in one embodiment, provides room to implement a tube-system, that can distribute gas or foam from an automated suppression system, which may be installed into the container or temporarily attached to the outside of the container for a use-case to be supply water, foam or fire-suppressant material to the inside of the container and has no impact on the outer dimensions of the shipping container.

The HCS 10 of the present disclosure allows an automobile that is on fire, at risk of catching fire or some other extreme condition to be pushed or pulled into the HCS 10. The construction of the HCS 10 will be robust in that they will contain an explosion should one occur and withstand extreme temperatures for an extended period of time allowing emergency personnel adequate time to arrive and extinguish the fire. Then the HCS 10 can be easily transported to a recycling or other facility, because it can be transported just like any other shipping container. Optionally, the HCS 10 also allows pressure from any potential explosion to be released through valves 50 in side-wall or roof of the HCS 10 preventing other damages through the explosion itself. Additionally, the revised seal and door system 60 of the container allow the container to be sealed against leakages and hence prevent from environmental damages, that would occur otherwise. The door system 60 may in one embodiment may be sealed double door of the shipping container or in other embodiments a single door, which may swing sideways or be used as a loading ramp and attached at the bottom of the container. The single loading ramp maybe pulled by rods through manual turn-wheels or by motors to pull the door shut or release and open the door for loading and unloading purposes.

Further advantages of the HCS 10 over the prior art are stackable units (due to using the outer shell 20 being from a shipping container) and adopting to necessary size by using either 10 feet long, 20 feet long or even 40 feet long standard shipping containers. Moreso, the availability of wide-spread standard shipping containers and the re-use of shipping containers as the outer liner 20 provides the ability to quickly distribute such HCS 10 to multiple places in shorter time.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

Although particular embodiments of the present disclosure have been described, it is not intended that such references be construed as limitations upon the scope of this disclosure except as set forth in the claims.

We claim:

1. A hazard containment system comprising at least an outer liner and an inner liner.

2. The hazard containment system of claim 1 further comprising a gap between the inner and outer liners.

3. The hazard containment system of claim 2 wherein the outer liner is comprised of steel.

4. The hazard containment system of claim 3 wherein the steel is corten steel.

5. The hazard containment system of claim 2 wherein the inner liner is comprised of steel.

6. The hazard containment system of claim 2 wherein the inner liner is comprised of ceramic tiles.

7. The hazard containment system of claim 2 further comprising a tube-system in the gap.

8. The hazard containment system of claim 7 wherein the tube system is adapter to distribute fire retardant gas or foam into the inner liner.

9. The hazard containment system of claim 4 wherein the inner liner is comprised of steel.

10. The hazard containment system of claim 4 wherein the inner liner is comprised of ceramic tiles.

11. The hazard containment system of claim 7 where the outer liner and inner liner are comprised of steel.

12. The hazard containment system of claim 7 where in the outer liner is comprised of steel and the inner liner is comprised of ceramic tiles.

13. The hazard containment system of claim 1 wherein the inner liner is removable from the outer liner.

14. The hazard containment system of claim 2 wherein the inner liner is removable from the outer liner.

15. The hazard containment system of claim 7 wherein the inner liner is removable from the outer liner.

16. The hazard containment system of claim 15 wherein the single door is also a loading ramp.

17. The hazard containment system of claim 8 further comprising a single door.

18. The hazard containment system of claim 14 wherein a single door is also a loading ramp.

19. The hazard containment system of claim 1 further comprising an adapter to which a fire hose may be connected and an opening on the roof of the containment system.

20. A hazard containment system comprising at least an outer liner and an inner liner, a single door, and a roof, wherein the roof further comprises an opening and the single door is also a loading ramp.
